(19) United States
(12) Patent Application Publication
(10) Pub. No.: US 2002/0155855 A1
(43) Pub. Date: Oct. 24, 2002

(54) Conversation timer for mobile phone

(76) Inventors: Yung-Tang Lee, Taipei (TW); Der-Kuei Wang, Taipei (TW)

Correspondence Address: BIRCH STEWART KOLASCH & BIRCH, PO BOX 747, FALLS CHURCH, VA, 22040-0747, US

(21) Appl. No.: 09/838,165

(22) Filed: Apr. 20, 2001

(51) Int. Cl. H04M 1/00; H04B 1/38

(52) U.S. Cl. 455/550; 455/90; 455/566; 455/575

(57) ABSTRACT

A conversation timer for mobile phone includes mainly a plurality of light emitting elements (such as light emitting diodes) located at the exterior of the mobile phone visible to the user. The light emitting elements will be turned on or off successively at a preset time interval to form a cumulative lighting when conversation starts on the mobile phone for indicating accumulated conversation time duration thereby to remind and alert user from using the mobile phone excessively.

### FIELD OF THE INVENTION

This invention relates to a timer for indicating conversation time duration of using a mobile phone and particularly a conversation timer for mobile phone that uses a plurality of controlled light emitting elements to remind user accumulated time being spent for each mobile phone conversation.

### BACKGROUND OF THE INVENTION

The fast growth and rapid development in mobile phone manufacturing industry and mobile communication services industry have greatly expanded the popularity of the mobile phone in recent years. Nowadays almost everyone carries one with them wherever they go. The modern mobile phones have many new function other than voice or message transmission. For instance, coupling with the Internet to offer multimedia function has become a mandatory feature for the new generation of the mobile phone. Current trend of mobile phone users is heavily shifting to the young people. In order to attract the purchasing of the youth group of consumers, the mobile phones have to have flashy and trendy design, and unique audio and video effects in addition to powerful digital function and capability.

To users who already have mobile phones, the main concerns are the possible healthy hazard of wireless electric wave to human body, communication time and charge. There are a lot of discussions and debates regard the possible or potential risk of wireless electric wave to human body. Although it is not yet conclusive, the public have general awareness that the mobile phones which emit too strong of wireless electric wave are harmful to human being. To cut short mobile phone using time closed to the head is one of the ways to reduce the risk. This also helps to reduce communication charge and is a commendable practice, for safety and economy purposes.

Most mobile phones now available on the market have a built-in timer to count and accumulate conversation time duration for each conversation or total usage time. Some even can calculate communication charge. However a large portion of the mobile phones can only provide inquiry information regard previous conversation time. The time counting and output format do not help much to the users who are currently using the mobile phones. There is no reminding or alerting effect. For the purpose of helping user to avoid using the mobile phone too long, it has limited preventive effect.

### SUMMARY OF THE INVENTION

It is therefore a primary object of this invention to provide a conversation timer for mobile phone that is capable of reminding and alerting users the accumulated conversation time duration.

Another object of this invention is to provide a conversation timer for mobile phone that is visible conspicuously and easy to see.

The conversation timer according to this invention includes a plurality of light emitting elements (such as light emitting diodes) disposed at the exterior of the mobile phone that are visible to the user. The light emitting elements are connected in a serial or annular fashion, and are activated successively by a timing driver device at a selected time interval to indicate accumulated conversation time elapsed for reminding and alerting the user.

The invention, as well as its many advantages, may be further understood by the following detailed description and drawings. The drawings are only to serve for reference and illustrative purpose, and do not intend to limit the scope of the present invention.

### BRIEF DESCRIPTION OF THE DRAWINGS

FIG. 1 is a structural block diagram of this invention.

FIG. 2 is a perspective view of an embodiment of this invention, with the light emitting elements engageable with the antenna.

FIG. 3A is a perspective view of another embodiment of this invention, with the light emitting elements engageable with the antenna.

FIG. 3B is an enlarged perspective view of the light emitting elements according to FIG. 3A.

FIG. 4 is an exploded view of yet another embodiment of this invention, with the light emitting elements located in the mobile phone processor.

FIG. 5 is a perspective view of still another embodiment of this invention, with the light emitting elements located at the exterior of the mobile phone processor

FIGS. 6A through 6E are schematic views of the light emitting elements in action, being lightened successively.

FIGS. 7A through 7E are schematic views of the light emitting elements in action, being turned off successively.

### DESCRIPTION OF THE PREFERRED EMBODIMENTS

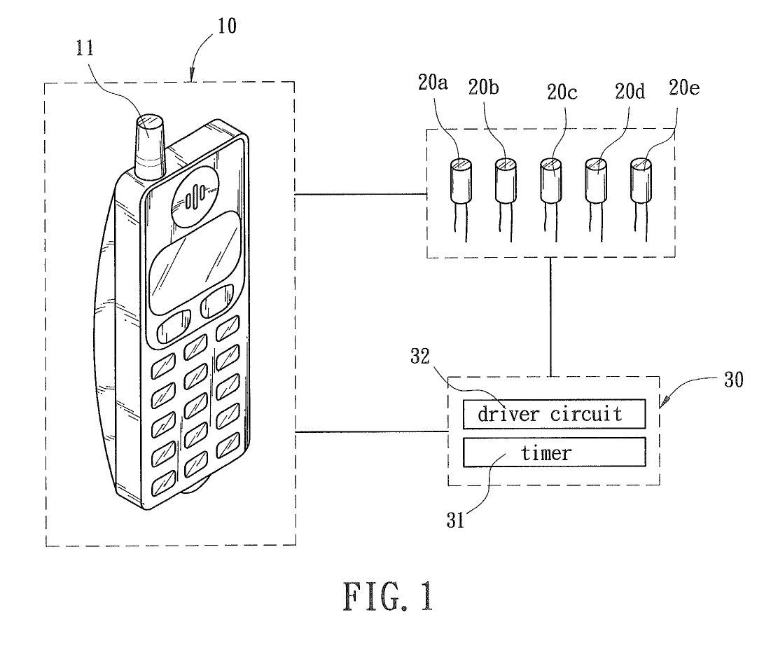

Referring to FIG. 1, in order to achieve the objects set forth above, this invention, in addition to a general mobile phone 10, includes the following elements:

A plurality of light emitting elements 20a-20e located on the mobile phone 10 and are visible to the user. The light emitting elements 20a-20e are closely adjacent to one another.

A timing driver device 30 which includes a timer 31 and a driver circuit 32 for activating the light emitting elements 20a-20e to turn on or off. When the mobile phone is started for conversation use, the timer 31 activates the driver circuit 32 at a preset time interval to drive (turn on or turn off) the light emitting elements 20a-20e successively one by one, and through accumulation of lighting status of the light emitting elements 20a-20e to remind or alert user the elapsed time having been used for the conversation.

The following embodiments use five sets of light emitting element 20a-20e as example. It is to be noted that other number of light emitting element may be used as required or desired.

Referring to GIG. 2 for the first embodiment, a plurality of light penetrable sleeve rings 12a-12e are mounted on the outer side of the antenna 11 of the mobile phone 10. The sleeve rings 12a-12e may be made of acrylic or plastics, and are axially stacked and adjacent to one another around the antenna 11. The light emitting elements 20a-20e are disposed respectively in the sleeve rings 12a-12e. Every time the mobile phone 10 is started for conversation, the timer 31 in the timing driver device 30 will activate the driver circuit 32 according to a preset time interval thereby to energize the light emitting elements 20a-20e. The lighting status of the light emitting elements 20a-20e may be used to indicate accumulated conversation time duration.

The light emitting elements 20a-20e may be activated in the following two operation schemes:

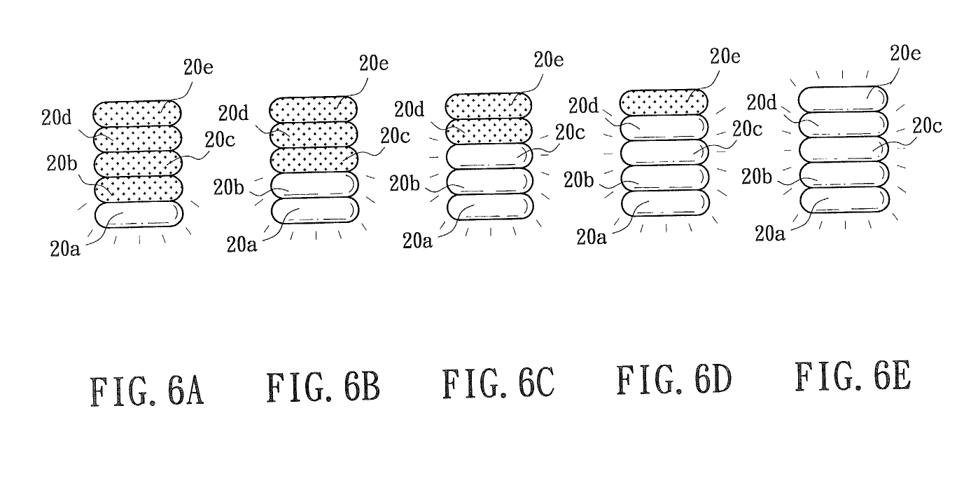

The first operation scheme is shown in FIGS. 6A through 6E in which all the light emitting elements 20a-20e are being turned on successively. When the conversation is initiated, all the light emitting elements 20a-20e (located respectively in the sleeve rings 12a-12e, not shown in the drawings) are at the turn-off state. When the timer 31 starts counting time for a preset interval (such as ten seconds), the first light emitting element 20a is turned on. As conversation progresses and time accumulated , the rest of the light emitting elements 20b-20e are being turned on successively. When all the light emitting elements 20a-20e have been turned on, and the mobile phone 10 is still being used for conversation, all the light emitting elements 20a-20e will be turned off again, and to repeat another cycle of lightening operation shown in FIGS. 6A-6E.

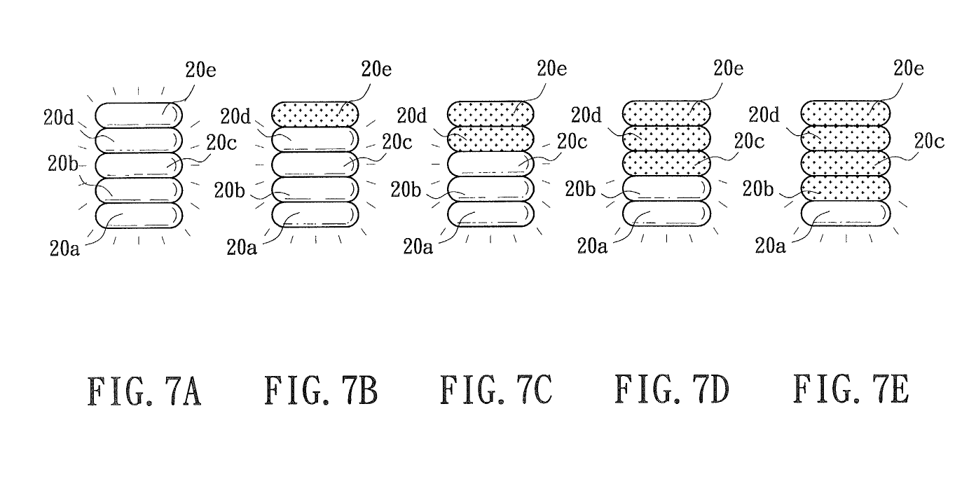

The second operation scheme is shown in FIGS. 7A through 7E in which all the light emitting elements 20a-20e are being turned off successively. When the conversation is initiated, all the light emitting elements 20a-20e (located respectively in the sleeve rings 12a-12e, not shown in the drawings) are at the lightening state. When the timer 31 starts counting time for a preset interval (such as ten seconds), the light emitting element 20e located at the top is turned off. As conversation progresses and time accumulated , the rest of the light emitting elements 20d-20a are being turned off successively. When all the light emitting elements 20a-20e have been turned off, and the mobile phone 10 is still being used for conversation, all the light emitting elements 20a-20e will be turned on again, and to repeat another cycle of turning off operation shown in FIGS. 7A-7E.

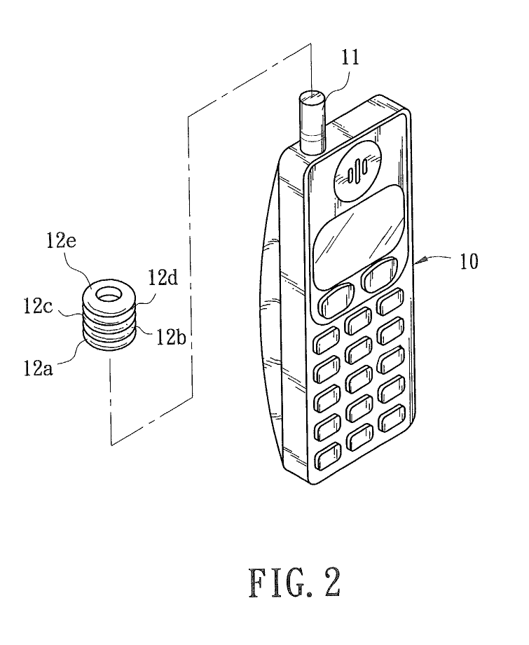

In the embodiment shown in FIG. 2, through observing the accumulating lighting status of all the light emitting elements 20a-20e, user will be reminded and alerted of the time duration for each conversation. The time interval of turning on or off for the light emitting elements 20a-20e may be set by user through the software built in the mobile phone 10 (such as ten seconds, twenty seconds, one minute, two minutes, or the like). Besides the accumulated lighting for indicating conversation time duration, every light emitting element 20a-20e may also be differentiated by different colors, such as red light to indicate longer conversation time to give user more effective alert.

In the embodiment shown in FIG. 2, the light emitting elements 20a-20e may be selected from light emitting diodes (LED) of monocolor types to stack one upon another for indicating accumulated conversation time duration. It also may use monocolor type LED to couple with the sleeve rings 12a-12e of different color to offer light of different colors. By the same token, tricolor type LED may also be directly used to generate light of different colors.

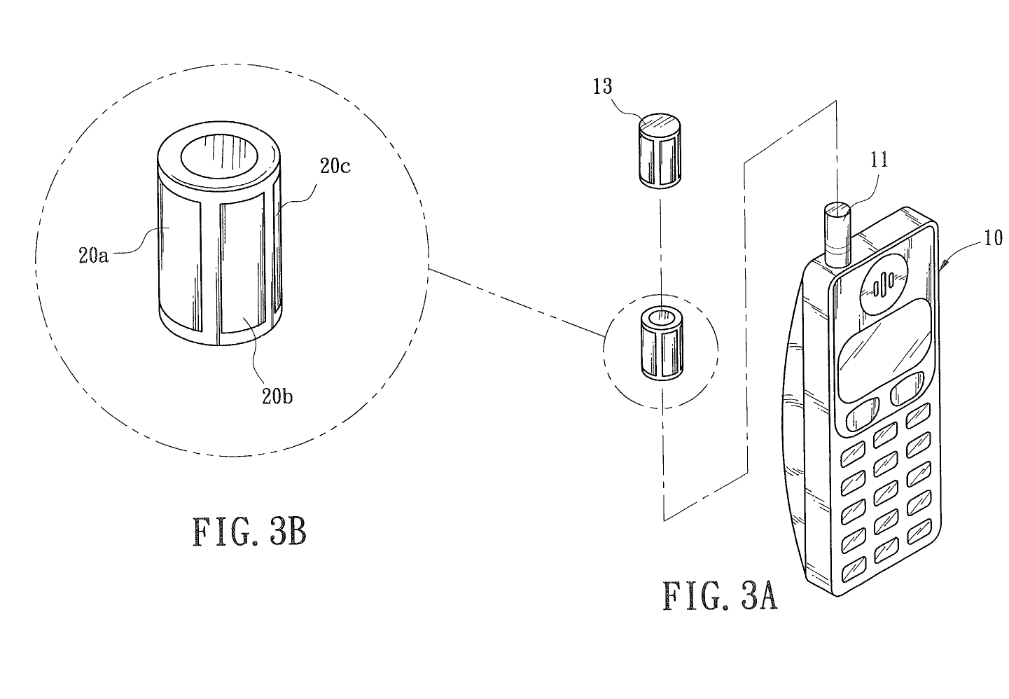

FIGS. 3A and 3B show another embodiment which uses laser light emitting strips as light emitting elements 20a-20e. The laser light emitting strip is a pliable thin plate capable of emitting fluorescent light, and may emit light when different voltage have been applied to two ends thereof. It may be formed in an annular shape to surround the antenna 11. The strips may also be covered respectively by light penetrable membranes 13 of different colors to generate different colors of light.

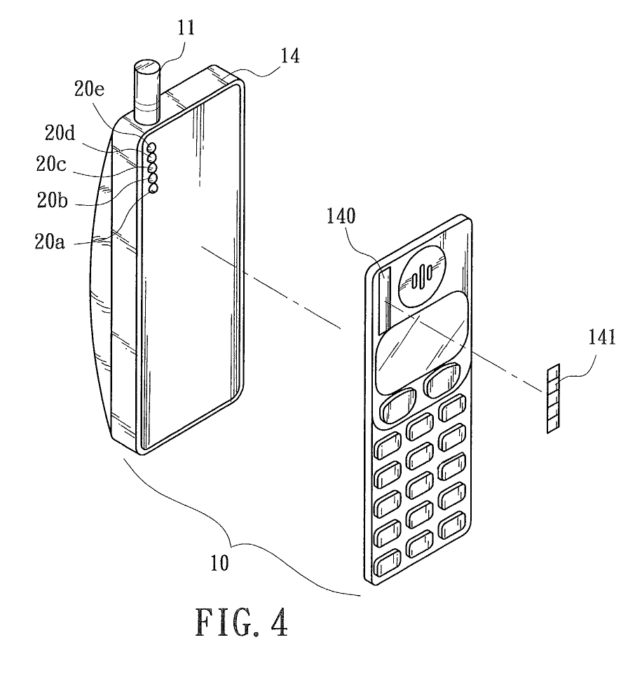

FIG. 4 shows yet another embodiment which has the light emitting elements 20a-20e disposed inside the processor 14 (such as circuit board) of the mobile phone 10. The processor 14 of the mobile phone 10 has a window 140 for viewing the lighting accumulation status of the light emitting elements 20a-20e. In this example, the light emitting elements 20a-20e are preferably chosen from LED, either monocolor type or tricolor type, or monocolor type LED coupled with light penetrable membrane 141a of different colors to cover the window 140 for generating different colors of light. Of course, laser light emitting strips may also be chosen as the light emitting elements 20a-20e to couple with light penetrable membrane 141a of different colors to cover the window 140 for generating different colors of light.

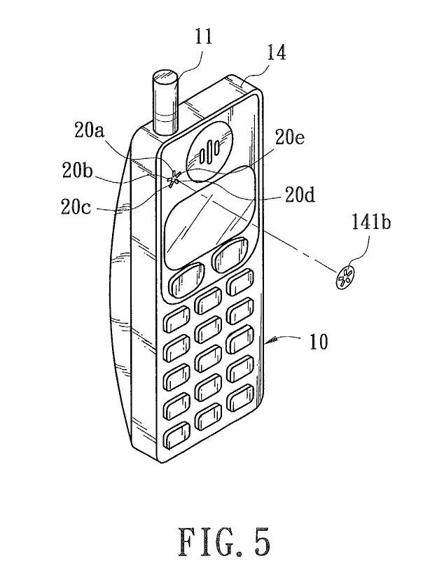

FIG. 5 shows still another embodiment which uses laser light emitting strips as the light emitting elements 20a-20e disposed at the exterior surface of the mobile phone processor 14. The laser light emitting strips may also be covered by light penetrable membrane 141a of different colors to generate different colors of light.

In the embodiments shown in FIGS. 4 and 5, the light emitting elements 20a-20e are disposed on a plane, thus may be arranged in any form desired, such as linear (shown in FIG. 4) or annular (shown in FIG. 5).

By means of aforesaid construction, users may be easily aware of the conversation time being used on the mobile phone through seeing the accumulated state of the light emitting elements, thereby get reminding or alarm to avoid using the mobile phone for an excessive period of time.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A conversation timer for a mobile phone, comprising:
a plurality of light emitting elements disposed in an adjacent fashion on the mobile phone at a location visible to the user; and
a timing driver device including a timer and a driver circuit, the timer activating the light emitting elements to turn on or off at a preset time interval when the mobile phone being started for conversation use, the light emitting elements being turned on or off successively in a cumulative manner for indicating accumulated time duration of the mobile phone being used for each conversation.

2. The conversation timer of claim 1, wherein the light emitting elements emit respectively light of different colors.

3. The conversation timer of claim 2, wherein the light emitting elements are mounted outside the exterior of the antenna of the mobile phone and are aligned and adjacent one another axially along the axis of the antenna.

4. The conversation timer of claim 3, wherein the light emitting elements are monocolor light emitting diodes which are respectively encased in light penetrable sleeve rings of different colors.

5. The conversation timer of claim 3, wherein the light emitting elements are tricolor light emitting diodes.

6. The conversation timer of claim 2, wherein the light emitting elements are located in the processor of the mobile phone which has a window for users to see lighting accumulation status of the light emitting elements.

7. The conversation timer of claim 6, wherein the light emitting elements are arranged in a linear fashion.

8. The conversation timer of claim 6, wherein the light emitting elements are arranged in an annular fashion.

9. The conversation timer of claim 6, wherein the light emitting elements are monocolor light emitting diodes and the window has light penetrable membranes of different colors disposed thereon.

10. The conversation timer of claim 6, wherein the light emitting elements are tricolor light emitting diodes.

11. The conversation timer of claim 6, wherein the light emitting elements are laser light emitting strips and the window has light penetrable membranes of different colors disposed thereon.

12. The conversation timer of claim 1, wherein the light emitting elements are laser light emitting strips located in an adjacent fashion at the exterior surface of the mobile phone, the laser light emitting strips being covered by light penetrable membranes of different colors.

13. The conversation timer of claim 12, wherein the laser light emitting strips are arranged in a linear fashion.

14. The conversation timer of claim 12, wherein the laser light emitting strips are arranged in an annular fashion.

15. The conversation timer of claim 2, wherein the light emitting elements surround the antenna of the mobile phone in an annular fashion.

16. The conversation timer of claim 15, wherein the light emitting elements are laser light emitting strips which have outer surface covered by light penetrable membrane of different colors

17. The conversation timer of claim 1, wherein the driver circuit activates the light emitting elements to turn on successively at a preset time interval when conversation on the mobile phone starts.

18. The conversation timer of claim 17, wherein the driver circuit turns off all the light emitting elements when the same have been turned on, then to repeatedly turn on the light emitting elements successively.

19. The conversation timer of claim 1, wherein the driver circuit activates the light emitting elements to turn off successively at a preset time interval when conversation on the mobile phone starts.

20. The conversation timer of claim 19, wherein the driver circuit turns on all the light emitting elements when the same have been turned off, then to repeatedly turn off the light emitting elements successively.
